(19) United States
(12) Patent Application Publication
(10) Pub. No.: US 2011/0130201 A1
(43) Pub. Date: Jun. 2, 2011

(54) GAME DEVICE, CONTROL METHOD FOR A GAME DEVICE, AND INFORMATION STORAGE MEDIUM

(75) Inventor: Shinta NOJIRI, Tokyo (JP)

(73) Assignee: KONAMI DIGITAL ENTERTAINMENT CO., LTD., Tokyo (JP)

(21) Appl. No.: 12/953,947

(22) Filed: Nov. 24, 2010

(30) Foreign Application Priority Data
Nov. 30, 2009 (JP) 2009-272899

(51) Int. Cl. G06F 17/00

(52) U.S. Cl. 463/31; 463/43

(57) ABSTRACT

A game device includes a first operation member and a second operation member. A first point control section causes a first point, which is set in a game space, to move based on a state of the first operation member. A second point control section causes a second point, which is set in the game space, to move based on a state of the second operation member. An object control section controls a position and a posture of an object, which is located in the game space, based on a position of the first point and a position of the second point. A display control section displays the object on a game screen.

### CROSS-REFERENCE TO RELATED APPLICATION

The present application claims priority from Japanese application JP 2009-272899 filed on Nov. 30, 2009, the content of which is hereby incorporated by reference into this application.

### BACKGROUND OF THE INVENTION

1. Field of the Invention

The present invention relates to a game device, a control method for a game device, and an information storage medium.

2. Description of the Related Art

For example, there is known a game configured such that a game character holds up or wields a weapon such as a sword in accordance with an operation by a player (for example, JP2004-174090A). In general, in such a game, in a case where the player has pressed a button of a controller, the game character wields the weapon, whereas in a case where the player has pressed another button of the controller, the game character holds up the weapon to take a defensive posture.

### SUMMARY OF THE INVENTION

For example, in the above-mentioned game, if the player can give a detailed instruction as to the way the weapon is to be held up or wielded, operability relating to operation of the weapon may be improved.

In view of the above-mentioned circumstances, the present invention has been made, and an object thereof is therefore to provide a game device, a control method for a game device, and an information storage medium, which enable a player to give a detailed instruction as to a position and a posture of an object, and thus are capable of improving operability of operation relating to the object.

In order to achieve the above-mentioned object, a game device according to the present invention is a game device including: a first operation member; a second operation member; a first point control section for causing a first point, which is set in a game space, to move based on a state of the first operation member; a second point control section for causing a second point, which is set in the game space, to move based on a state of the second operation member; an object control section for controlling a position and a posture of an object, which is located in the game space, based on a position of the first point and a position of the second point; and a display control section for displaying the object on a game screen.

Further, a control method for a game device according to the present invention is a control method for a game device including a first operation member and a second operation member, the control method including: a first point control step of causing a first point, which is set in a game space, to move based on a state of the first operation member; a second point control step of causing a second point, which is set in the game space, to move based on a state of the second operation member; an object control step of controlling a position and a posture of an object, which is located in the game space, based on a position of the first point and a position of the second point; and a display control step of displaying the object on a game screen.

Further, a program according to the present invention is a program for causing a computer, such as a consumer game machine (stationary game machine), a portable game machine, an arcade game machine, a mobile phone, a personal digital assistant (PDA), or a personal computer, to function as: a first point control section for causing a first point, which is set in a game space, to move based on a state of a first operation member; a second point control section for causing a second point, which is set in the game space, to move based on a state of a second operation member; an object control section for controlling a position and a posture of an object, which is located in the game space, based on a position of the first point and a position of the second point; and a display control section for displaying the object on a game screen.

Further, an information storage medium according to the present invention is a computer-readable information storage medium storing the above-mentioned program.

According to the present invention, by using the first operation member and the second operation member, the player can give a detailed instruction as to the position and the posture of the object. As a result, operability relating to the operation of the object may be improved.

Further, according to one aspect of the present invention, the object may comprise an object representing a thing held by a game character, the first point control section may cause the first point to move based on the state of the first operation member in a first region, which is set based on a position of the game character, and the second point control section may cause the second point to move based on the state of the second operation member in a second region, which is set based on the position of the game character.

Further, according to one aspect of the present invention, a first object representing the first region and a second object representing the second region may be located in the game space based on the position of the game character, the first point control section may cause the first point to move at least one of on a surface of and inside the first object based on the state of the first operation member, and the second point control section may cause the second point to move at least one of on a surface of and inside the second object based on the state of the second operation member.

Further, according to one aspect of the present invention, at least one of the first region and the second region may be changed in at least one of shape, size, and positional relation with respect to the game character, based on a kind of the object.

Further, according to one aspect of the present invention, at least one of the first region and the second region may be changed in at least one of shape, size, and positional relation with respect to the game character, based on a kind of the game character.

Further, according to one aspect of the present invention, the object may have a longitudinal shape, and the object control section may control the position and the posture of the object so that a longitudinal direction of the object coincides with a direction determined based on a direction extending from the first point to the second point.

Further, according to one aspect of the present invention, the display control section may include a section for displaying an afterimage of the object on the game screen in a case where a change amount of the position and the posture of the object per predetermined time period is larger than a reference amount.

Further, according to one aspect of the present invention, the object control section may include a section for acquiring a change direction of the position and the posture of the object as a basic direction in a case where a change amount of the position and the posture of the object per predetermined time period is larger than a reference amount, and based on the basic direction the object control section may correct the change direction of the position and the posture of the object after the basic direction is acquired.

### BRIEF DESCRIPTION OF THE DRAWINGS

In the accompanying drawings:

FIG. 1 is a diagram illustrating a hardware configuration of a game device according to an embodiment of the present invention;

FIG. 2A is a diagram illustrating one example of a controller;

FIG. 2B is a diagram illustrating the one example of the controller;

FIG. 3 is a diagram illustrating one example of a game space;

FIG. 4 is a diagram illustrating one example of a game screen;

FIG. 5 is a diagram illustrating one example of the game screen;

FIG. 6 is a functional block diagram of the game device according to the embodiment of the present invention;

FIG. 7 is a diagram for describing one example of a first point and a second point;

FIG. 8 is a diagram for describing a function of a first point control section;

FIG. 9 is a diagram for describing a surface of a first region object;

FIG. 10 is a diagram for describing a function of a second point control section;

FIG. 11 is a diagram for describing a surface of a second region object;

FIG. 12 is a diagram for describing control of a position and a posture of a sword object, which is performed by an object control section;

FIG. 13 is a flow chart illustrating one example of processing to be executed on the game device;

FIG. 14 is a flow chart illustrating one example of the processing to be executed on the game device; and

FIG. 15 is a diagram for describing one example of correction of movement of the sword object.

### DETAILED DESCRIPTION OF THE INVENTION

Hereinbelow, detailed description is given of an exemplary embodiment of the present invention based on the accompanying drawings. A game device according to the embodiment of the present invention is implemented by, for example, a consumer game machine (stationary game machine), a portable game machine, a mobile phone, a personal digital assistant (PDA), a personal computer, or the like. In this specification, description is given of a case where the game device according to the embodiment of the present invention is implemented by a consumer game machine.

### [Hardware Configuration]

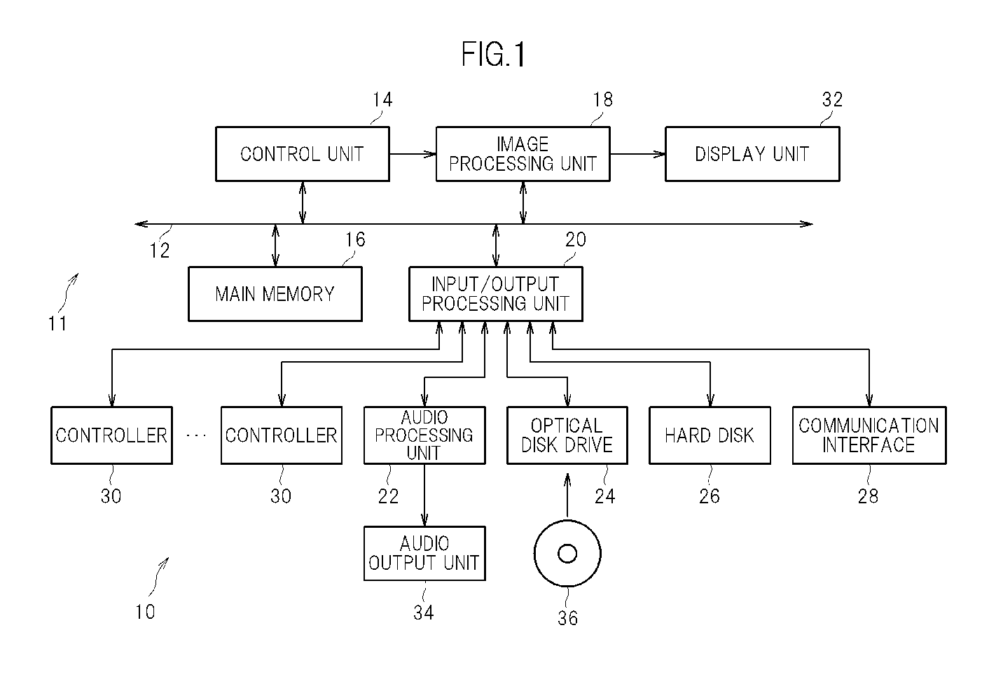

FIG. 1 illustrates a hardware configuration of the game device according to the embodiment of the present invention. A game device 10 illustrated in FIG. 1 includes a consumer game machine 11, a display unit 32, an audio output unit 34, and an optical disk 36 (information storage medium). The display unit 32 and the audio output unit 34 are connected to the consumer game machine 11. For example, a home-use television set or a liquid crystal display is used as the display unit 32. For example, a speaker built into the home-use television set or a headphone is used as the audio output unit 34.

The consumer game machine 11 is a publicly-known computer game system. The consumer game machine 11 includes a bus 12, a control unit 14, a main memory 16, an image processing unit 18, an input/output processing unit 20, an audio processing unit 22, an optical disk drive 24, a hard disk 26, a communication interface 28, and a controller 30.

The control unit 14 includes one or a plurality of microprocessors. The control unit 14 executes information processing based on an operating system stored in a ROM (not shown) and a program read from the optical disk 36. The main memory 16 includes a RAM, for example, and programs and data read from the optical disk 36 are written into the main memory 16. The main memory 16 is also used as a working memory for the control unit 14. The bus 12 is used for communicating addresses and data among the units of the consumer game machine 11.

The image processing unit 18 includes a VRAM, and renders a game screen in the VRAM based on image data supplied from the control unit 14. The game screen rendered in the VRAM is converted into video signals, and the signals are then output to the display unit 32 at a predetermined timing.

The input/output processing unit 20 is an interface for the control unit 14 to access the audio processing unit 22, the optical disk drive 24, the hard disk 26, the communication interface 28, and the controller 30. The audio processing unit 22 includes a sound buffer, and outputs, from the audio output unit 34, audio data loaded from the optical disk 36 into the sound buffer. The communication interface 28 is an interface for connecting the consumer game machine 11 by wire or wireless to a communication network, such as the Internet.

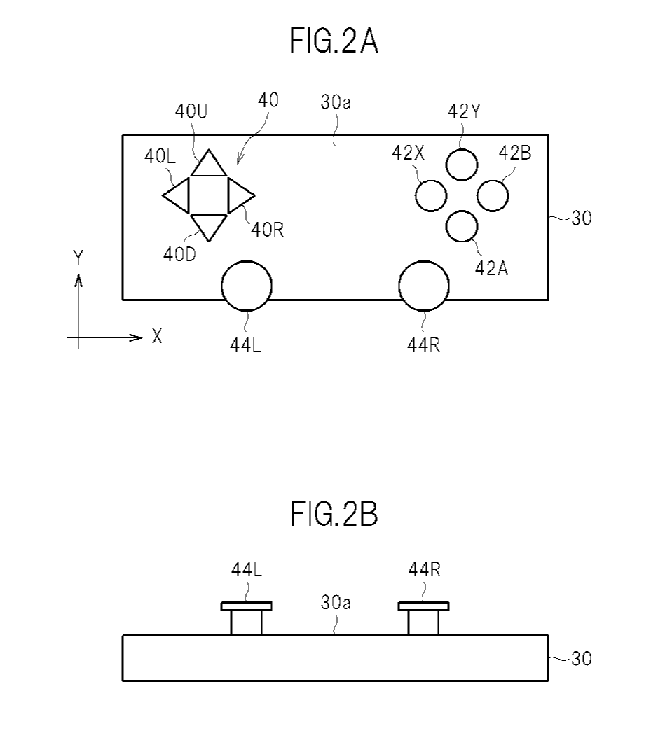

The optical disk drive 24 reads programs and data recorded in the optical disk 36. In this specification, the optical disk 36 is used to supply programs and data to the consumer game machine 11, but another information storage medium, such as a memory card, may be used. Further, for example, programs and data may be supplied to the consumer game machine 11 from a remote location via a communication network. The hard disk 26 is a commonly-used hard disk device (auxiliary storage device). It should be noted that the programs and data that are described as being stored in the optical disk 36 may be stored in the hard disk 26 instead. The controller 30 is an operation unit for receiving game operations performed by a player. One or a plurality of the controllers 30 are connected to the consumer game machine 11 by wire or wireless. FIG. 2A and FIG. 2B illustrate one example of the controller 30. It should be noted that, in FIG. 2A, an X-axis corresponds to a long-axis direction of the controller 30 (left-right direction), and a Y-axis corresponds to a short-axis direction of the controller 30 (up-down direction). The X-axis and the Y-axis are orthogonal to each other.

A front side 30a of the controller 30 includes a plurality of operation members. For example, the front side 30a of the controller 30 includes a direction button group 40, buttons 42A, 42B, 42X, and 42Y, a left stick (lever) 44L, and a right stick (lever) 44R.

The direction button group 40 is used for an operation of specifying a direction, for example. The direction button group 40 includes an up direction button 40U corresponding to an upward direction, a down direction button 40D corresponding to a downward direction, a left direction button 40L corresponding to a leftward direction, and a right direction button 40R corresponding to a rightward direction.

The up direction button 40U is configured as a pressure-sensitive button. For example, the up direction button 40U is provided with a pressure-sensitive sensor, from which pressing-force information relating to a pressing force exerted onto the up direction button 40U is supplied to the control unit 14. The pressing force is expressed by a numerical value ranging, for example, from 0 to 255. Similarly to the up direction button 40U, the down direction button 40D, the left direction button 40L, and the right direction button 40R are each configured as a pressure-sensitive button, and pressing-force information relating to a pressing force exerted onto each of those buttons is supplied to the control unit 14 as well.

The left stick 44L and the right stick 44R are used for the operation of specifying a direction as well, for example. The left stick 44L and the right stick 44R stand upright on the front side 30a of the casing of the controller 30, and are configured to be freely tilted to a predetermined angle in every direction from the upright state.

Tilt information relating to tilts of the left stick 44L in the left-right direction and the up-down direction is supplied to the control unit 14. For example, the amount of a tilt in the left-right direction is expressed by a numerical value ranging, for example, from −127 to +127. The value “0” indicates that the left stick 44L is not tilted in the X-axis direction (left-right direction). Further, the value “+127” indicates that the left stick 44L is tilted to its limit in the positive direction of the X-axis (rightward direction). Further, the value “−127” indicates that the left stick 44L is tilted to its limit in the negative direction of the X-axis (leftward direction). The same applies to tilts in the up-down direction. Further, the right stick 44R operates in the same manner as the left stick 44L. It should be noted that, hereinbelow, a state in which the left stick 44L is not tilted in any of the left-right direction and the up-down direction is referred to as the left stick 44L being in a “neutral state”. The same applies to the right stick 44R.

The buttons 42A, 42B, 42X, and 42Y are used for various kinds of game operations. It should be noted that, similarly to the direction button group 40, the buttons 42A, 42B, 42X, and 42Y are each configured as a pressure-sensitive button, and pressing-force information relating to a pressing force exerted onto each of those buttons is supplied to the control unit 14.

The input/output processing unit 20 scans a state of each of the operation members of the controller 30 at fixed intervals (for example, every 1/60^{th} of a second), and then supplies an operation signal representing scan results thus obtained to the control unit 14 via the bus 12. The pressing-force information of the direction button group 40 and the tilt information of each of the left stick 44L and the right stick 44R are also supplied to the control unit 14 as the operation signal. Based on the operation signal, the control unit 14 determines a game operation performed by the user.

### [Game]

In the game device 10, a game program read from the optical disk 36 is executed, to thereby execute, for example, an action game. In the action game, there appear a game character (hereinbelow, referred to as “player character”) operated by a player and a game character (hereinbelow, referred to as “enemy character”) that confronts the player character. The player operates the player character to fight off the enemy character.

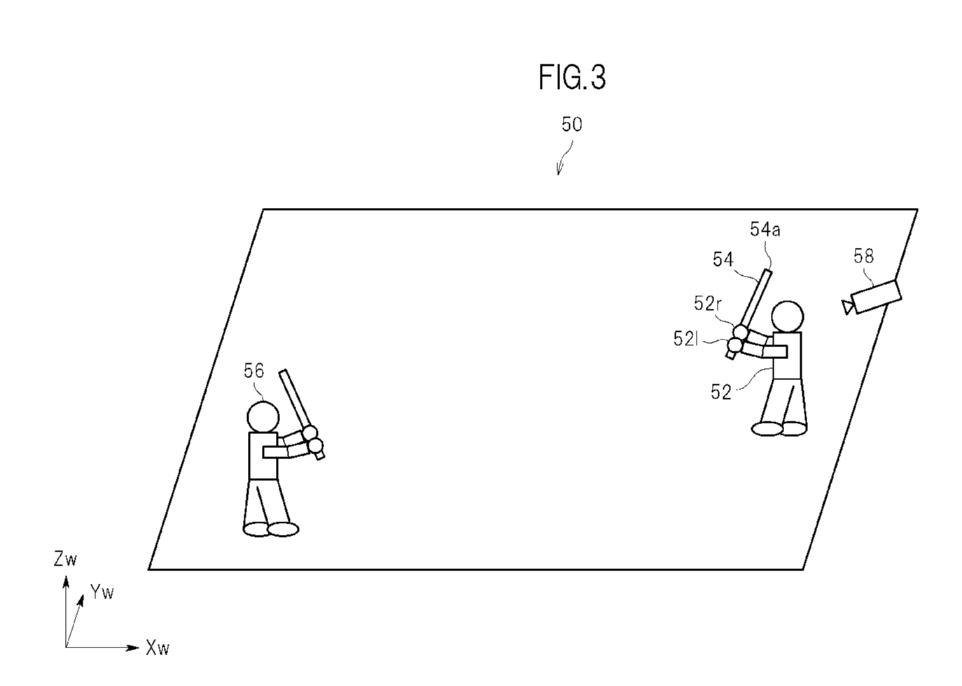

When the game program is executed, a game space is built in the main memory 16. FIG. 3 illustrates one example of the game space. A game space 50 illustrated in FIG. 3 is a virtual three-dimensional space in which three coordinate axes orthogonal to one another (Xw-axis, Yw-axis, and Zw-axis) are set. As illustrated in FIG. 3, a player character 52, which is a game character object operated by the player, and an enemy character 56, which is a game character object that confronts the player character 52, are disposed in the game space 50.

The player character 52 holds a sword object 54 representing a sword. The sword object 54 has a longitudinal shape. In the example illustrated in FIG. 3, the sword object 54 is an object in a rod shape. The player character 52 holds the sword object 54 by grasping one end side of the sword object 54 with a left hand 521 and a right hand 52r. It should be noted that the player character 52 may hold an object other than the sword object 54. For example, the player character 52 may hold a katana (Japanese sword) object, an axe object, a rod object, or the like.

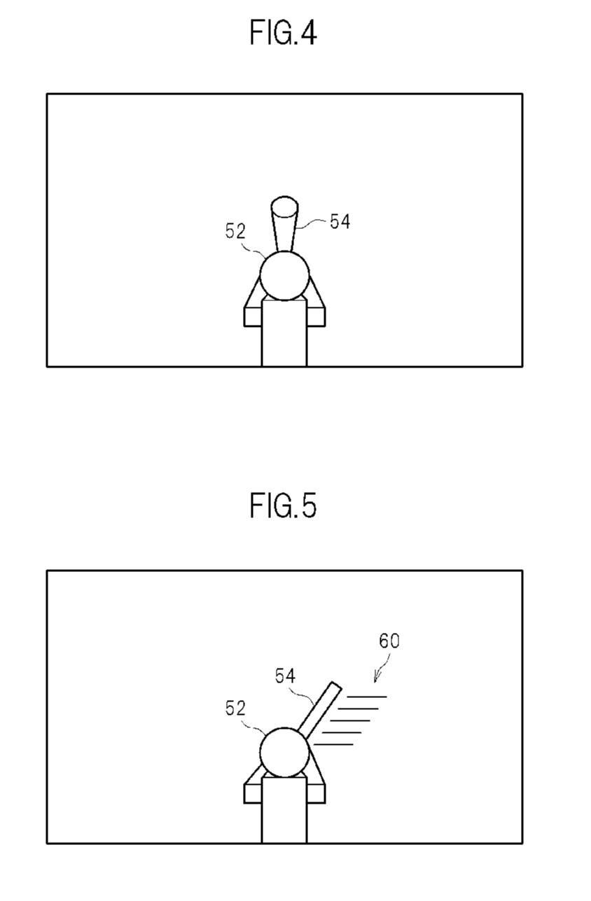

Further, a virtual camera 58 is set in the game space 50. For example, the position of the virtual camera 58 is set at a high place behind the player character 52. An image representing the game space 50 viewed from the virtual camera 58 is displayed on a game screen. FIG. 4 illustrates one example of the game screen displayed on the display unit 32. FIG. 4 illustrates a scene in which the player character 52 has raised the sword object 54. As illustrated in FIG. 4, the player character 52 and the sword object 54, which are viewed from the high place behind the player character 52, are displayed on the game screen. It should be noted that in a case where the enemy character 56 is included in the field of view of the virtual camera 58, the enemy character 56 is also displayed on the game screen.

The player character 52 holds up the sword object 54 or wields the sword object 54 in accordance with an operation by the player. FIG. 5 illustrates one example of the game screen for a case where the player character 52 is wielding the sword object 54. As illustrated in FIG. 5, in the game screen for the case where the player character 52 is wielding the sword object 54 for an attack, an afterimage 60 of the sword object 54 is displayed. This display of the afterimage 60 allows the player to easily recognize how the sword object 54 is being wielded.

According to this embodiment, the player is allowed to make the player character 52 perform a wide variety of swordplay. Specifically, by using the left stick 44L and the right stick 44R, the player can give a detailed instruction as to the way the sword object 54 is to be held up or wielded. For example, the player can change the position of the left hand 521 (or the right hand 52r) of the player character 52 by tilting the left stick 44L. Further, the player can change the position of a tip portion 54a of the sword object 54 by tilting the right stick 44R. Hereinbelow, detailed description is given of this configuration.

### [Functional Blocks]

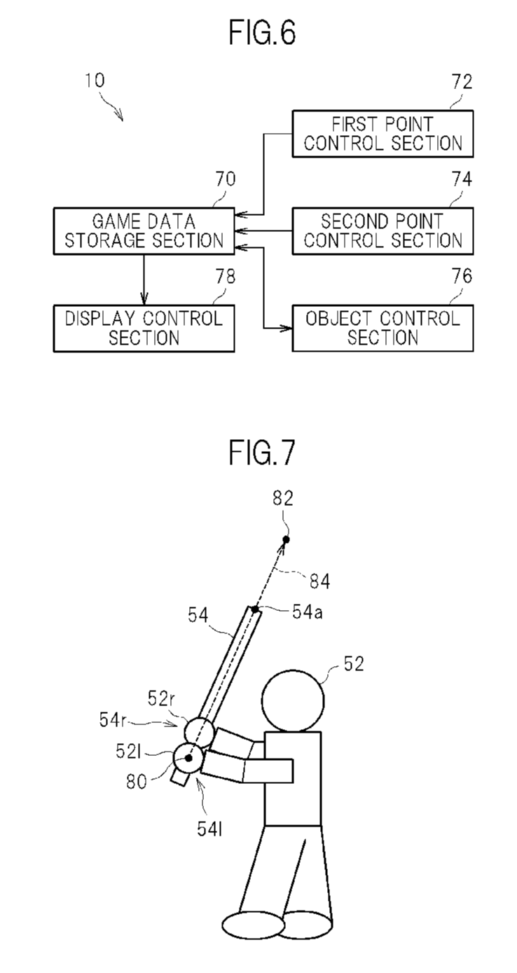

FIG. 6 is a functional block diagram illustrating functions to be implemented on the game device 10. As illustrated in FIG. 6, the game device 10 includes a game data storage section 70, a first point control section 72, a second point control section 74, an object control section 76, and a display control section 78. The game data storage section 70 is implemented by, for example, the main memory 16 and the optical disk 36. The other functional blocks are implemented by, for example, the control unit 14 executing the programs stored in the optical disk 36.

The game data storage section 70 stores various kinds of data necessary for executing the game. For example, the game data storage section 70 stores model data relating to the shape of each of the objects disposed in the game space 50. Further, for example, the game data storage section 70 stores game situation data relating to a current situation of the game. For example, the game situation data includes data relating to the state (for example, position, posture, etc.) of each of dynamic objects (player character 52, sword object 54, and enemy character 56) disposed in the game space 50, and data relating to the state (for example, position, line of sight, angle of view, etc.) of the virtual camera 58.

Here, description is given of data relating to the state of the sword object 54. In this embodiment, a first point and a second point, which are to serve as a basis of control of the state (for example, position and posture) of the sword object 54, are set in the game space 50. FIG. 7 is provided to describe one example of the first point and the second point.

For example, a first point 80 is a point used for controlling the position of a first portion of the sword object 54, and is associated with the first portion of the sword object 54. For example, the above-mentioned “first portion” is a grip portion 541 of the sword object 54, which is gripped by the left hand 521 of the player character 52. It should be noted that the above-mentioned “first portion” may be a grip portion 54r of the sword object 54, which is gripped by the right hand 52r of the player character 52.

Further, for example, a second point 82 is a point used for controlling the position of a second portion of the sword object 54, and is associated with the second portion of the sword object 54. For example, the above-mentioned “second portion” is the tip portion 54a of the sword object 54.

In the case of this embodiment, the positions of the first point 80 and the second point 82 are contained in the data relating to the state of the sword object 54.

Here, in this embodiment, the first point 80 and the second point 82 are set such that, when the longitudinal direction of the sword object 54 coincides with a direction 84 extending from the first point 80 to the second point 82, the length between the first point 80 and the second point 82 becomes longer than the length of the sword object 54 in the longitudinal direction.

The first point control section 72 causes the first point 80 set in the game space 50 to move based on the state (operation state) of a first operation member. For example, the first point control section 72 causes the first point 80 to move, based on the state of the first operation member, in a first region that is set based on the position of the game character. Hereinbelow, detailed description is given of the function of the first point control section 72.

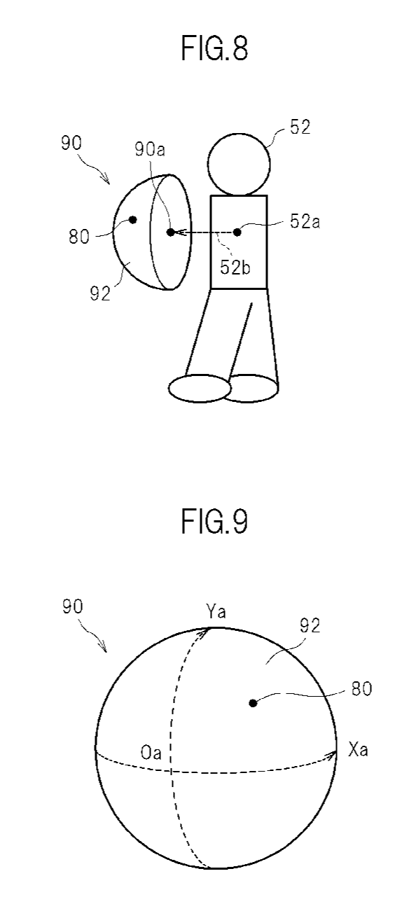

FIG. 8 is a diagram for describing the function of the first point control section 72. It should be noted that, in FIG. 8, the arms of the player character 52 and the sword object 54 are omitted. As illustrated in FIG. 8, a first region object 90 representing the first region, in which the first point 80 is movable, is disposed in the game space 50. As described below, in the case of this embodiment, the first point 80 is allowed to move on a surface 92 of the first region object 90, and hence the surface 92 of the first region object 90 corresponds to the region (first region) in which the first point 80 is movable.

The first region object 90 is an invisible object that is set to be transparent. That is, the first region object 90 is restrained (inhibited) from being displayed in the game screen. The position of the first region object 90 is set based on the position of the player character 52. In the case of this embodiment, the position of the first region object 90 and the position of the player character 52 always have a fixed relation.

As described above, the surface 92 of the first region object 90 represents the region (first region) in which the first point 80 is movable, and the first point 80 is the point for controlling the position of the grip portion 541 of the sword object 54. Thus, the shape and the size of the first region object 90 (that is, first region), and the positional relation between the first region object 90 (that is, first region) and the player character 52 are determined in consideration of such a region that the left hand 521 of the player character 52 can reach.

In the example illustrated in FIG. 8, the first region object 90 is disposed such that a representative point 90a of the first region object 90 is positioned a fixed distance away in a front-side direction 52b from a representative point 52a of the player character 52. Further, in the example illustrated in FIG. 8, the shape of the first region object 90 is such a shape that defines part of a sphere. Specifically, the shape of the first region object 90 is semi-spherical. It should be noted that the shape of the first region object 90 is not limited to the shape (for example, semi-spherical shape) that defines part of a sphere.

FIG. 9 is a diagram for describing the surface 92 of the first region object 90. As illustrated in FIG. 9, a first axis (Xa-axis) and a second axis (Ya-axis), which intersect each other, are set on the surface 92. The Xa-axis and the Ya-axis intersect each other at an origin point Oa, which corresponds to a center of the surface 92.

The first point control section 72 causes the first point 80 to move on the surface 92 of the first region object 90 based on the state of the first operation member. In the case of this embodiment, the left stick 44L corresponds to the “first operation member”.

The Xa-axis of FIG. 9 corresponds to the X-axis of FIG. 2A, and the Ya-axis of FIG. 9 corresponds to the Y-axis of FIG. 2A. In the case where the left stick 44L is in the neutral state, the first point control section 72 sets the first point 80 to the origin point Oa.

In a case where the left stick 44L is tilted in the positive direction of the X-axis (or in the negative direction of the X-axis) illustrated in FIG. 2A, the first point control section 72 causes the first point 80 to move in the positive direction of the Xa-axis (or in the negative direction of the Xa-axis) illustrated in FIG. 9. In this case, a Xa-axis coordinate value of the first point 80 is set to a coordinate value that corresponds to the amount of tilt of the left stick 44L in the X-axis direction.

Further, in a case where the left stick 44L is tilted in the positive direction of the Y-axis (or in the negative direction of the Y-axis) illustrated in FIG. 2A, the first point control section 72 causes the first point 80 to move in the positive direction of the Ya-axis (or in the negative direction of the Ya-axis) illustrated in FIG. 9. In this case, a Ya-axis coordinate value of the first point 80 is set to a coordinate value that corresponds to the amount of tilt of the left stick 44L in the Y-axis direction.

In a case where the left stick 44L is returned to the neutral state after the left stick 44L is tilted in the X-axis direction and/or the Y-axis direction, the first point control section 72 causes the first point 80 to return to the origin point Oa.

It should be noted that the region in which the first point 80 is movable may not be limited to the surface 92 of the first region object 90. For example, the first point 80 may be caused to move within an inside of the first region object 90. In this case, the inside of the first region object 90 corresponds to the region (first region) in which the first point 80 is movable. In this manner, at least one of the surface 92 and the inside of the first region object 90 needs to correspond to the region (first region) in which the first point 80 is movable.

The second point control section 74 causes the second point 82 set in the game space 50 to move based on the state (operation state) of a second operation member. The secondpoint control section 74 causes the second point 82 to move based on the state of the second operation member in a second region that is set based on the position of the game character. Hereinbelow, detailed description is given of the function of the second point control section 74.

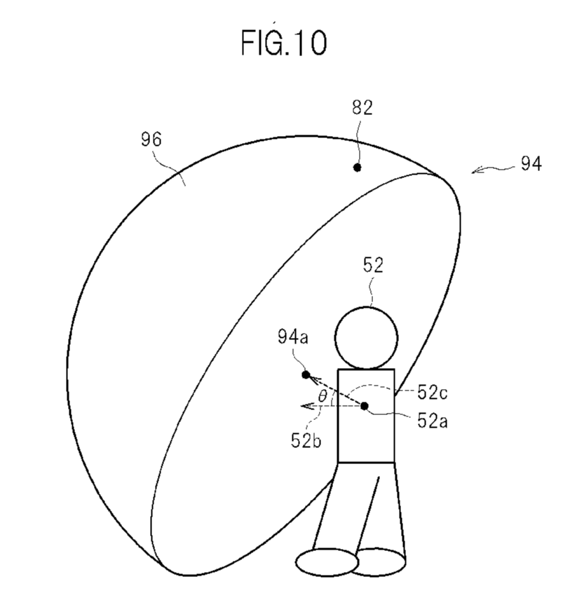

FIG. 10 is a diagram for describing the function of the second point control section 74. It should be noted that, also in FIG. 10, the arms of the player character 52 and the sword object 54 are omitted. As illustrated in FIG. 10, a second region object 94 representing the second region, in which the second point 82 is movable, is disposed in the game space 50. As described below, in the case of this embodiment, the second point 82 is allowed to move on a surface 96 of the second region object 94, and hence the surface 96 of the second region object 94 corresponds to the region (second region) in which the second point 82 is movable.

In the case of this embodiment, the second region object 94 is a larger object than the first region object 90. Similarly to the first region object 90, the second region object 94 is an invisible object that is set to be transparent. That is, the second region object 94 is restrained (inhibited) from being displayed on the game screen. The position of the second region object 94 is set based on the position of the player character 52. In the case of this embodiment, the position of the second region object 94 and the position of the player character 52 always have a fixed relation.

As described above, the surface 96 of the second region object 94 represents the region (second region) in which the second point 82 is movable, and the second point 82 is the point for controlling the position of the tip portion 54a of the sword object 54. Thus, the shape and the size of the second region object 94 (that is, second region) and the positional relation between the second region object 94 and the player character 52 are determined in consideration of such a region that the tip portion 54a of the sword object 54 can reach.

In the example illustrated in FIG. 10, the second region object 94 is disposed such that a representative point 94a of the second region object 94 is positioned a fixed distance away in an obliquely forward and upward direction 52c from the representative point 52a of the player character 52. It should be noted that an angle θ formed between the front-side direction 52b of the player character 52 and the direction 52c is always constant. Further, in the example illustrated in FIG. 10, the shape of the second region object 94 is such a shape that defines part of a sphere. Specifically, the shape of the second region object 94 is semi-spherical. It should be noted that the shape of the second region object 94 is not limited to the shape (for example, semi-spherical shape) that defines part of a sphere.

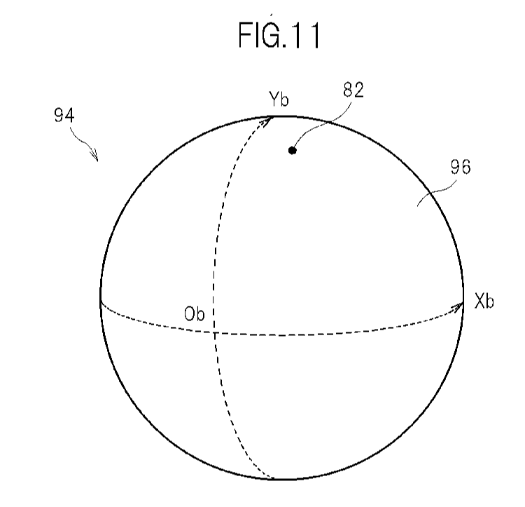

FIG. 11 is a diagram for describing the surface 96 of the second region object 94. A third axis (Xb-axis) and a fourth axis (Yb-axis), which intersect each other, are set on the surface 96. The Xb-axis and the Yb-axis intersect each other at an origin point Ob, which corresponds to a center of the surface 96.

The second point control section 74 causes the second point 82 to move on the surface 96 of the second region object 94 based on the state of the second operation member. In the case of this embodiment, the right stick 44R corresponds to the “second operation member”.

The Xb-axis of FIG. 11 corresponds to the X-axis of FIG. 2A, and the Yb-axis of FIG. 11 corresponds to the Y-axis of FIG. 2A. In a case where the right stick 44R is in the neutral state, the second point control section 74 sets the second point 82 to the origin point Ob.

In a case where the right stick 44R is tilted in the positive direction of the X-axis (or in the negative direction of the X-axis) illustrated in FIG. 2A, the second point control section 74 causes the second point 82 to move in the positive direction of the Xb-axis (or in the negative direction of the Xb-axis) illustrated in FIG. 11. In this case, a Xb-axis coordinate value of the second point 82 is set to a coordinate value that corresponds to the amount of tilt of the right stick 44R in the X-axis direction.

Further, in a case where the right stick 44R is tilted in the positive direction of the Y-axis (or in the negative direction of the Y-axis) illustrated in FIG. 2A, the second point control section 74 causes the second point 82 to move in the positive direction of the Yb-axis (or in the negative direction of the Yb-axis) illustrated in FIG. 11. In this case, a Yb-axis coordinate value of the second point 82 is set to a coordinate value that corresponds to the amount of tilt of the right stick 44R in the Y-axis direction.

In a case where the right stick 44R is returned to the neutral state after the right stick 44R is tilted in the X-axis direction and/or the Y-axis direction, the second point control section 74 causes the second point 82 to return to the origin point Ob.

It should be noted that the region in which the second point 82 is movable may not be limited to the surface 96 of the second region object 94. For example, the second point 82 may be caused to move within an inside of the second region object 94. In this case, the inside of the second region object 94 corresponds to the region (second region) in which the second point 82 is movable. In this manner, at least one of the surface 96 and the inside of the second region object 94 needs to correspond to the region (second region) in which the second point 82 is movable.

The object control section 76 controls the position and the posture of the object disposed in the game space 50 based on the first point 80 and the second point 82. For example, the “object” relates to an object having the longitudinal shape. Further, for example, the “object” relates to an object representing a thing to be held by the player character 52 when used. In the case of this embodiment, the sword object 54 corresponds to the “object” that is to be controlled by the object control section 76.

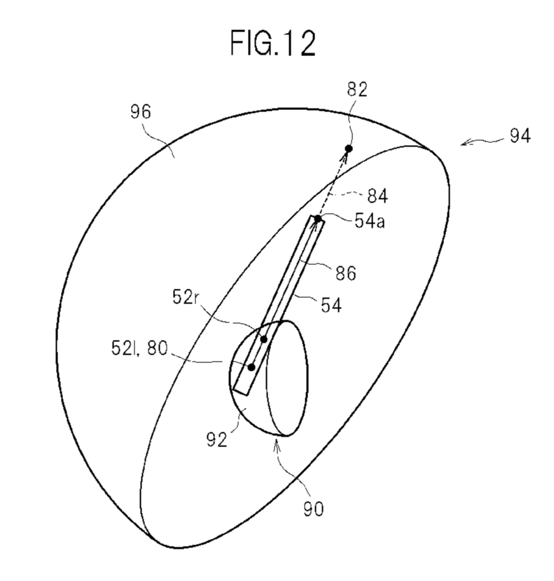

FIG. 12 is a diagram for describing control of the position and the posture of the sword object 54, which is performed by the object control section 76. FIG. 12 illustrates a relation among the first point 80 (first region object 90), the second point 82 (second region object 94), and the sword object 54. In the case of this embodiment, the object control section 76 controls the position and the posture of the sword object 54 based on the direction 84 extending from the first point 80 to the second point 82. More specifically, the object control section 76 controls the position and the posture of the sword object 54 so that the longitudinal direction (direction 86 extending from the grip portion 541 to the tip portion 54a) of the sword object 54 coincides with the direction 84 extending from the first point 80 to the second point 82.

The display control section 78 displays the game space 50 viewed from the virtual camera 58 in the game screen (see FIG. 4 and FIG. 5).

Further, in a case where the amount of movement of the sword object 54 per predetermined time period is larger than a reference amount, the display control section 78 displays the afterimage 60 of the sword object 54 on the game screen (see FIG. 5). It should be noted that the “amount of movement” is a numerical value indicating the extent of the movement of the sword object 54, and may be translated as, for example, a change amount indicating the extent of change in position and/or posture of the sword object 54. The case where the amount of movement of the sword object 54 per predetermined time period is larger than the reference amount is represented by, for example, a case where the player character 52 has wielded the sword object 54 quickly, that is, a case where the player character 52 has made an attack. With this configuration, in the case where the player character 52 has wielded the sword object 54 quickly (in the case where the player character 52 has made an attack), the afterimage 60 of the sword object 54 is displayed on the game screen.

### [Processing]

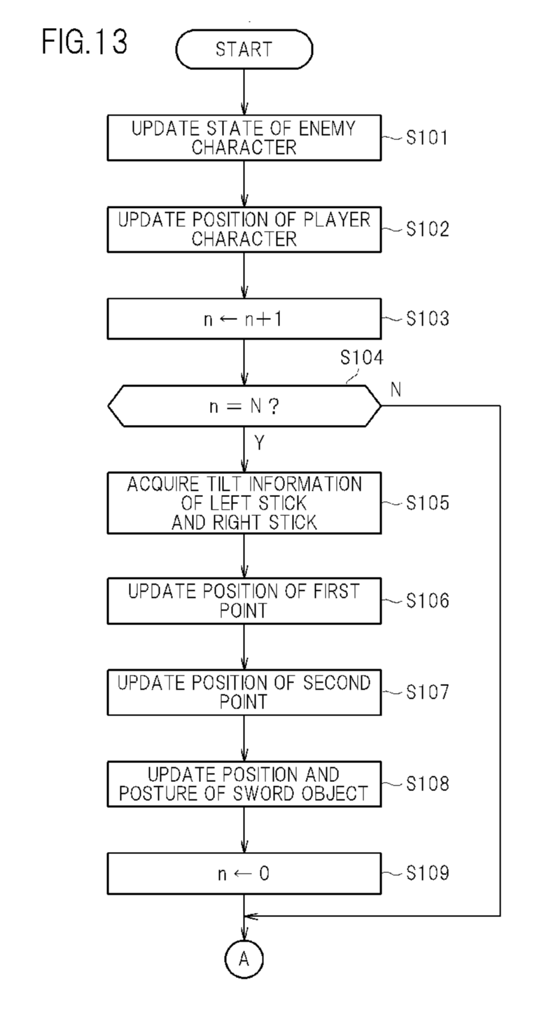

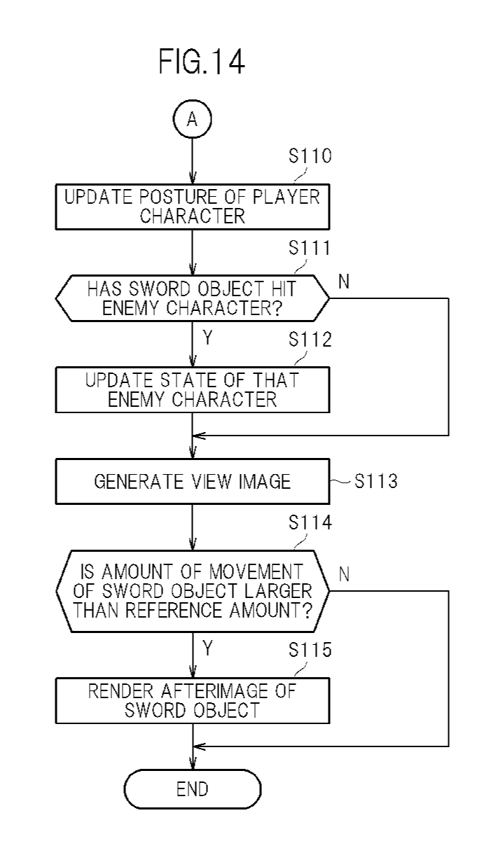

Description is given of processing to be executed on the game device 10. FIG. 13 and FIG. 14 are flow charts that mainly illustrate, of the processing to be executed on the game device 10, processing regarding the control of the sword object 54. In accordance with the program stored in the optical disk 36, the control unit 14 executes the processing illustrated in FIG. 13 and FIG. 14 at predetermined time intervals (in this embodiment, 1/60^{th} of a second). The control unit 14 executes the processing illustrated in FIG. 13 and FIG. 14, to thereby implement the first point control section 72, the second point control section 74, the object control section 76, and the display control section 78.

As illustrated in FIG. 13, the control unit 14 updates the state of the enemy character 56 (S101). For example, the control unit 14 updates the position of the enemy character 56, to thereby cause the enemy character 56 to move. Further, for example, the control unit 14 causes the enemy character 56 to make an attack against the player character 52.

Further, the control unit 14 updates the position of the player character 52 (S102). For example, the control unit 14 causes the player character 52 to move based on the operation of the player. For example, the left stick 44L may be used for an operation of moving the player character 52. More specifically, in the case where the right stick 44R is in the neutral state, the control unit 14 may cause the player character 52 to move based on the state (tilt direction) of the left stick 44L.

It should be noted that another operation member than the left stick 44L and the right stick 44R may be used for the operation of moving the player character 52. For example, the direction button group 40 may be used. In this case, the control unit 14 causes the player character 52 to move based on the state (depression state) of the direction button group 40.

After the processing of Step S102 is completed, the control unit 14 adds one to a variable n (S103). The variable n is initialized to 0 when the game starts. As described below, the variable n is used for setting an execution interval for processing of from Step S105 to Step S108 to an interval (for example, N/60^{th} of a second: N is an integer equal to or larger than 2) longer than the execution interval for the overall processing (for example, 1/60^{th} of a second).

The control unit 14 determines whether or not the variable n is N (for example, 4) (S104). In a case where the variable n is N, the control unit 14 executes the processing of from Step S105 to Step S108.

That is, the control unit 14 acquires the tilt information of the left stick 44L and the right stick 44R (S105). Then, the control unit 14 (first point control section 72) updates the position of the first point 80 based on the tilt information of the left stick 44L (S106).

For example, the control unit 14 updates the Xa-axis coordinate value of the first point 80 based on a numerical value indicating the tilt of the left stick 44L in the left-right direction (X-axis direction). Information that associates the numerical value indicating the tilt of the left stick 44L in the left-right direction with the Xa-axis coordinate value is stored in the game data storage section 70. The Xa-axis coordinate value of the first point 80 is determined based on this information.

Further, the control unit 14 updates the Ya-axis coordinate value of the first point 80 based on a numerical value indicating the tilt of the left stick 44L in the up-down direction (Y-axis direction). Information that associates the numerical value indicating the tilt of the left stick 44L in the up-down direction with the Ya-axis coordinate value is stored in the game data storage section 70. The Ya-axis coordinate value of the first point 80 is determined based on this information.

After the processing of Step S106 is completed, the control unit 14 (second point control section 74) updates the position of the second point 82 based on the tilt information of the right stick 44R (S107).

For example, the control unit 14 updates the Xb-axis coordinate value of the second point 82 based on a numerical value indicating the tilt of the right stick 44R in the left-right direction (X-axis direction). Information that associates the numerical value indicating the tilt of the right stick 44R in the left-right direction with the Xb-axis coordinate value is stored in the game data storage section 70. The Xb-axis coordinate value of the second point 82 is determined based on this information.

Further, the control unit 14 updates the Yb-axis coordinate value of the second point 82 based on a numerical value indicating the tilt of the right stick 44R in the up-down direction (Y-axis direction). Information that associates the numerical value indicating the tilt of the right stick 44R in the up-down direction with the Yb-axis coordinate value is stored in the game data storage section 70. The Yb-axis coordinate value of the second point 82 is determined based on this information.

After the processing of Step S107 is completed, the control unit 14 (object control section 76) updates the position and the posture of the sword object 54 based on the positions of the first point 80 and the second point 82 (S108). For example, the control unit 14 sets the position of the grip portion 541 of the sword object 54 based on the first point 80, and sets the position of the tip portion 54a of the sword object 54 based on the direction 84 extending from the first point 80 to the second point 82.

More specifically, as illustrated in FIG. 12, the control unit 14 causes the position of the grip portion 541 of the sword object 54 to coincide with the position of the first point 80. Further, the control unit 14 sets the position of the tip portion 54a of the sword object 54 so that the longitudinal direction (direction 86 extending from the grip portion 541 to the tip portion 54a) of the sword object 54 coincides with the direction 84 extending from the first point 80 to the second point 82. In this case, the position of the tip portion 54a of the sword object 54 is located on a straight line extending in the direction 84 from the first point 80 to the second point 82, and is also set to have a predetermined distance from the grip portion 541.

After the processing of Step S108 is completed, the control unit 14 initializes the variable n to 0 (S109). Here, description is given of the significance of the processing of from Step S104 to Step S109. Even when the player thinks that they are keeping the tilt states of the left stick 44L and the right stick 44R constant, the tilt states of the left stick 44L and the right stick 44R often change slightly every 1/60^{th} of a second. Accordingly, if the processing of from Step S105 to Step S108 is executed every 1/60^{th} of a second as well, the position and the posture of the sword object 54 change every 1/60^{th} of a second. Consequently, the sword object 54 is displayed as if to be trembling, which causes the player to have a feeling of unnaturalness. In this respect, as in this embodiment, if the execution interval for the processing of from Step S105 to Step S108 (in other words, update processing for the position and the posture of the sword object 54) is set to an interval (for example, N/60^{th} of a second) longer than the execution interval (for example, 1/60^{th} of a second) for the overall processing (in other words, update processing for the states of the player character 52 and the enemy character 56), it is possible to reduce the feeling of unnaturalness described above.

In the case where the processing of Step S109 is completed, or in a case where it is determined in Step S104 that the variable n is not N, as illustrated in FIG. 14, the control unit 14 updates the posture of the player character 52 (S110). In Step S110, the posture of the player character 52 is set based on at least one of the positions of the first point 80 and the second point 82.

For example, in Step S110, the control unit 14 first determines, of portions of the player character 52, the position of a portion with which the player character 52 grasps the sword object 54. Specifically, the control unit 14 determines the position of the grip portion 541 of the sword object 54 as the position of the left hand 521 of the player character 52. It should be noted that, as described above, the position of the grip portion 541 of the sword object 54 is determined based on the first point 80, and thus the position of the left hand 521 of the player character 52 may be considered to be determined based on the first point 80.

Further, the control unit 14 determines the position of the grip portion 54r of the sword object 54 as the position of the right hand 52r of the player character 52. It should be noted that the position of the grip portion 54r of the sword object 54 is determined based on the positions of the first point 80 and the second point 82, and thus the position of the right hand 52r of the player character 52 may be considered to be determined based on the first point 80 and the second point 82.

After that, the control unit 14 determines the positions and the like of other portions of the player character 52 based on the positions of the left hand 521 and the right hand 52r of the player character 52. For example, a skeleton for controlling the positions of the respective portions of the player character 52 (in other words, posture of the player character 52) is set inside the player character 52. In Step S110, by determining the state of the skeleton based on the positions of the left hand 521 and the right hand 52r, the positions and the like of the other portions of the player character 52 are determined. It should be noted that, when the state of the skeleton is determined based on the positions of the left hand 521 and the right hand 52r, for example, a general inverse kinematics algorithm is used.

After the processing of Step S110 is completed, the control unit 14 determines whether or not the sword object 54 has hit the enemy character 56 (S111). In Step S111, a general collision detection algorithm is used.

In a case where the sword object 54 has hit the enemy character 56, the control unit 14 updates the state of the enemy character 56 (S112). For example, the state is updated to a state in which the enemy character 56 has been fought off.

In a case where the processing of Step S112 is completed, or in a case where it is determined in Step S111 that the sword object 54 has not hit the enemy character 56, the control unit 14 (display control section 78) generates a view image showing the game space 50 viewed from the virtual camera 58 in the VRAM (S113).

After that, the control unit 14 (display control section 78) determines whether or not the amount of movement of the sword object 54 is larger than the reference amount (S114). In Step S114, for example, the change amount of the position of the tip portion 54a of the sword object 54 is used as the “amount of movement”. It should be noted that the change amount of the position of the second point 82 may be used as the “amount of movement”.

In a case where the amount of movement of the sword object 54 is larger than the reference amount, the control unit 14 (display control section 78) renders the afterimage 60 of the sword object 54 on the view image generated in the VRAM (S115). For example, a history of the position of the sword object 54 is stored in the main memory 16, and a rendering position of the afterimage 60 of the sword object 54 is determined based on the history of the position of the sword object 54.

The image generated in the VRAM through the processing of from Steps S113 to S115 is displayed on the display unit 32 as the game screen. With this, this processing is ended.

### [Summary]

In the game device 10 described above, the first point 80 and the second point 82 are set in the game space 50, which are used as a basis for the control of the sword object 54. The position of the first point 80 is controlled based on the tilt state of the left stick 44L, and the position of the second point 82 is controlled based on the tilt state of the right stick 44R. Then, the position and the posture of the sword object 54 are controlled based on the positions of the first point 80 and the second point 82.

According to the game device 10, the position and the posture of the sword object 54 are changed minutely based on the tilt states of the left stick 44L and the right stick 44R. Therefore, according to the game device 10, by using the left stick 44L and the right stick 44R, the player can give a detailed instruction as to the way the sword object 54 is to be held up or wielded. In other words, according to the game device 10, it is possible to improve operability of operation relating to the sword object 54 held by the player character 52.

Incidentally, as a method for giving a detailed instruction as to the way the sword object 54 is to be held up or wielded, such a method is conceivable that uses a controller equipped with a built-in acceleration sensor or the like. However, in this case, the controller 30 needs to incorporate an acceleration sensor or the like. In this respect, according to this embodiment, the controller 30 does not need to incorporate an acceleration sensor or the like.

It should be noted that, in the game device 10, the first region object 90 is disposed in the game space 50, and the region in which the first point 80 is movable is limited to the surface 92 of the first region object 90. Similarly, the second region object 94 is disposed in the game space 50, and the region in which the second point 82 is movable is limited to the surface 96 of the second region object 94. The position and the posture of the sword object 54 are changed based on the positions of the first point 80 and the second point 82, and hence a possible way to hold up or wield the sword object 54 for the player character 52 changes depending on the shapes and sizes of the first region object 90 and the second region object 94, and the positional relations thereof with respect to the player character 52.

According to the game device 10, a person who creates the shapes and the like of objects to be disposed in the game space 50 in game development may be involved in decision-making as to the possible way to hold up or wield the sword object 54 for the player character 52.

### Modification Examples

It should be noted that the present invention is not limited to the embodiment described above.

(1) For example, the object control section 76 may correct the movement of the sword object 54 in the case where the player character 52 wields the sword object 54 (that is, in the case where the player character 52 makes an attack).

In the case where the player character 52 wields the sword object 54, if the sword object 54 is caused to move exactly according to operations of the left stick 44L and the right stick 44R, there is a case in which the movement of the sword object 54 becomes unnatural. In this respect, a configuration described below may be adopted to prevent the movement of the sword object 54 from becoming unnatural.

In this case, the object control section 76 determines whether or not the amount of movement of the sword object 54 per predetermined time period is larger than the reference amount. That is, the object control section 76 determines whether or not the player character 52 is wielding the sword object 54 quickly (whether or not the player character 52 is making an attack). This determination is executed in the same manner as in Step S114 of FIG. 14.

In the case where the amount of movement of the sword object 54 per predetermined time period is larger than the reference amount, the object control section 76 acquires a change direction of the position and the posture of the sword object 54 as a basic direction. Then, based on the basic direction, the object control section 76 corrects the change direction of the position and the posture of the sword object 54 after the basic direction is acquired.

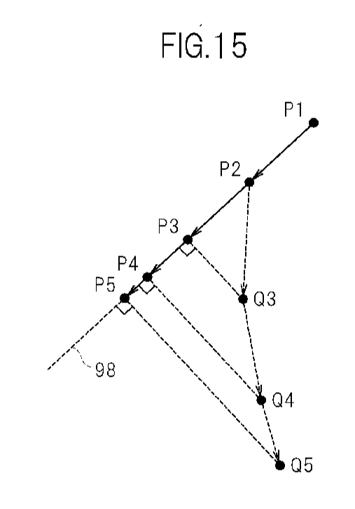

FIG. 15 is a diagram for describing the correction of the movement of the sword object 54. For example, even in a case where the player performs an operation with an intention of wielding the sword object 54 so that the tip portion 54a of the sword object 54 draws a linear trajectory (P1 to P5) as illustrated in FIG. 15, in actuality, there is a case in which the player ends up performing such an operation that causes the tip portion 54a to draw a curvilinear trajectory (P1, P2, Q3, Q4, and Q5) as illustrated in FIG. 15. This is more likely to occur in a case where the player operates the left stick 44L and the right stick 44R with their left and right thumbs. In such a case, the player may feel that the movement of the sword object 54 is unnatural.

In view of this, in a case where the amount of movement obtained when the position of the tip portion 54a of the sword object 54 changes from P1 to P2 is larger than the reference amount, the object control section 76 acquires the direction from P1 to P2 as the basic direction. After that, the object control section 76 corrects the position of the tip portion 54a of the sword object 54 so as to be at the foot of the normal drawn from the original position of the tip portion 54a to a straight line 98 extending in the basic direction. For example, in a case where the original position of the tip portion 54a of the sword object 54 is Q3, the object control section 76 corrects the position of the tip portion 54a of the sword object 54 so as to be the position (P3) of the foot of the normal drawn from the original position (Q3) to the straight line 98. With this configuration, it is possible to prevent the player from feeling that the movement of the sword object 54 is unnatural.

It should be noted that, here, description has been given of an example in which the position of the tip portion 54a of the sword object 54 is corrected, but the position of the second point 82 may be corrected instead of the tip portion 54a of the sword object 54.

Further, the correction of the movement of the sword object 54 may be ended in a case where a predetermined time has elapsed after the sword object 54 started being wielded for an attack. Further, the correction of the movement of the sword object 54 may be ended in a case where the amount of movement of the sword object 54 has become equal to or less than the reference amount.

(2) For example, the first point 80 may be associated with a portion of the sword object 54 other than the grip portion 541. For example, the first point 80 may be associated with the grip portion 54r of the sword object 54. In this case, the shape and the size of the first region object 90 (that is, first region) and the positional relation thereof with respect to the player character 52 are set in consideration of such a region that the right hand 52r of the player character 52 can reach.

(3) For example, the second point 82 may be associated with a portion of the sword object 54 other than the tip portion 54a. For example, the second point 82 may be associated with the grip portion 54r of the sword object 54. In this case, the shape and the size of the second region object 94 (that is, second region) and the positional relation thereof with respect to the player character 52 are set in consideration of such a region that the right hand 52r of the player character 52 can reach. Further, also in this case, the object control section 76 controls the posture of the sword object 54 so that the longitudinal direction of the sword object 54 coincides with the direction 84 extending from the first point 80 to the second point 82.

It should be noted that, in the case where the distance from the first point 80 to the second point 82 is long, the region (second region) in which the second point 82 is movable becomes larger, compared to the case where the distance from the first point 80 to the second point 82 is short, and hence it is easier to adjust the movement of the sword object 54 (tip portion 54a) to be smooth.

(4) For example, another operation member may be used instead of the left stick 44L. For example, the direction button group 40 may be used. In this case, the first point control section 72 causes the first point 80 to move based on the depression state of the direction button group 40. In this case, instead of the tilts of the left stick 44L in the left-right direction and the up-down direction, pressing forces exerted onto the left direction button 40L, the right direction button 40R, the up direction button 40U, and the down direction button 40D are used.

It should be noted that the controller 30 may be provided with a cross button having a cross shape, instead of the direction button group 40. For example, the cross button is a button in which an up depression portion corresponding to the upward direction, a down depression portion corresponding to the downward direction, a left depression portion corresponding to the leftward direction, and a right depression portion corresponding to the rightward direction are formed in an integral manner.

Further, instead of the direction button group 40, the buttons 42A, 42B, 42X, and 42Y may be used in place of the left stick 44L. In this case, the button 42Y may be considered to correspond to the up direction button 40U, and the button 42A may be considered to correspond to the down direction button 40D. Further, the button 42X may be considered to correspond to the left direction button 40L, and the button 42B may be considered to correspond to the right direction button 40R.

Similarly to the left stick 44L, another operation member may be used instead of the right stick 44R.

(5) For example, the player character 52 may hold a weapon object other than the sword object 54. It should be noted that, in a case where the player character 52 switches over among a plurality of kinds of weapon objects, at least one of the region (first region) in which the first point 80 is movable and the region (second region) in which the second point 82 is movable may be changed depending on the weapon object. Specifically, at least one of the shape(s), the size(s), and the positional relation(s) with respect to the player character 52 of the first region object 90 and/or the second region object 94 may be changed based on the kind of the weapon object. In this case, data on at least one of the shape(s), the size(s), and the positional relation(s) with respect to the player character 52 of the first region object 90 and/or the second region object 94 needs to be stored in the game data storage section 70 depending on the kind of the weapon object. With this configuration, the way the weapon object is to be held up or wielded may be changed depending on the kind of the weapon object.

(6) For example, in a case where the player character 52 is selected from among a plurality of kinds of game characters, at least one of the region (first region) in which the first point 80 is movable and the region (second region) in which the second point 82 is movable may be changed depending on the game character. Specifically, at least one of the shape(s), the size(s), and the positional relation(s) with respect to the player character 52 of the first region object 90 and/or the second region object 94 may be changed based on the kind of the game character. In this case, data on at least one of the shape(s), the size(s), and the positional relation(s) with respect to the player character 52 of the first region object 90 and/or the second region object 94 needs to be stored in the game data storage section 70 depending on the kind of the game character. With this configuration, the way the sword object 54 is to be held up or wielded may be changed depending on the kind of the game character.

(7) For example, the game space may be such a two-dimensional game space that the positions and the postures of the player character, the sword, and the enemy character are managed with two coordinate elements.

(8) For example, the present invention is also applicable to such a game that the player character 52 holds an object other than the weapon object. The present invention is also applicable to a game other than the action game. For example, the present invention is also applicable to a baseball game in which the player character holds a bat object. In this case, the player can give a detailed instruction as to the way the bat object is to be held up or swung. Further, for example, the present invention is also applicable to such a game that the game character pulls on oars. In this case, the player can give a detailed instruction as to the way the oars are to be pulled.

It should be noted that the object to be controlled by the object control section 76 does not need to be an object having the longitudinal shape, and also does not need to be an object to be held by a game character. For example, the present invention is applicable to such a game that the player uses the left stick 44L and the right stick 44R to finely adjust the posture of an object floating in the game space.

(9) While there have been described what are at present considered to be certain embodiments of the invention, it will be understood that various modifications may be made thereto, and it is intended that the appended claims cover all such modifications as fall within the true spirit and scope of the invention.

What is claimed is:

1. A game device, comprising:
a first operation member;
a second operation member;
a first point control section for causing a first point, which is set in a game space, to move based on a state of the first operation member;
a second point control section for causing a second point, which is set in the game space, to move based on a state of the second operation member;
an object control section for controlling a position and a posture of an object, which is located in the game space, based on a position of the first point and a position of the second point; and
a display control section for displaying the object on a game screen.

2. The game device according to claim 1, wherein:
the object comprises an object representing a thing held by a game character;
the first point control section causes the first point to move based on the state of the first operation member in a first region, which is set based on a position of the game character; and
the second point control section causes the second point to move based on the state of the second operation member in a second region, which is set based on the position of the game character.

3. The game device according to claim 2, wherein:
a first object representing the first region and a second obj ect representing the second region are located in the game space based on the position of the game character;
the first point control section causes the first point to move at least one of on a surface of and inside the first object based on the state of the first operation member; and
the second point control section causes the second point to move at least one of on a surface of and inside the second object based on the state of the second operation member.

4. The game device according to claim 2, wherein at least one of the first region and the second region is changed in at least one of shape, size, and positional relation with respect to the game character, based on a kind of the object.

5. The game device according to claim 2, wherein at least one of the first region and the second region is changed in at least one of shape, size, and positional relation with respect to the game character, based on a kind of the game character.

6. The game device according to claim 1, wherein:
the object has a longitudinal shape; and
the object control section controls the position and the posture of the object so that a longitudinal direction of the object coincides with a direction determined based on a direction extending from the first point to the second point.

7. The game device according to claim 1, wherein the display control section comprises a section for displaying an afterimage of the object on the game screen in a case where a change amount of the position and the posture of the object per predetermined time period is larger than a reference amount.

8. The game device according to claim 1, wherein:
the object control section comprises a section for acquiring a change direction of the position and the posture of the object as a basic direction in a case where a change amount of the position and the posture of the object per predetermined time period is larger than a reference amount; and
based on the basic direction, the object control section corrects the change direction of the position and the posture of the object after the basic direction is acquired.

9. A control method for a game device comprising a first operation member and a second operation member,
the control method comprising:
a first point control step of causing a first point, which is set in a game space, to move based on a state of the first operation member;
a second point control step of causing a second point, which is set in the game space, to move based on a state of the second operation member;
an object control step of controlling a position and a posture of an object, which is located in the game space, based on a position of the first point and a position of the second point; and
a display control step of displaying the object on a game screen.

10. A computer-readable information storage medium storing a program, the program causing a computer to function as:
a first point control section for causing a first point, which is set in a game space, to move based on a state of a first operation member;
a second point control section for causing a second point, which is set in the game space, to move based on a state of a second operation member;
an object control section for controlling a position and a posture of an object, which is located in the game space, based on a position of the first point and a position of the second point; and
a display control section for displaying the object on a game screen.
